(19) United States
(12) Patent Application Publication
(10) Pub. No.: US 2025/0185118 A1
(43) Pub. Date: Jun. 5, 2025

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/048,159

(22) Filed: Feb. 7, 2025

Related U.S. Application Data
(63) Continuation of application No. PCT/JP2023/028759, filed on Aug. 7, 2023.
(60) Provisional application No. 63/396,349, filed on Aug. 9, 2022.

(51) Int. Cl. H04W 76/40; H04W 76/34

(52) U.S. Cl. CPC H04W 76/40; H04W 76/34

(57) ABSTRACT

A communication method used in a mobile communication system that provides a multicast/broadcast service (MBS), the communication method including the steps of: receiving, by a user equipment in a radio resource control (RRC) connected state, a multicast session from a network; and transmitting, by the user equipment, a message to the network, the message including first information indicating that the user equipment desires to transition to an RRC inactive state and second information regarding continuation of reception of the multicast session.

### RELATED APPLICATIONS

The present application is a continuation based on PCT Application No. PCT/JP2023/028759, filed on Aug. 7, 2023, which claims the benefit of U.S. Provisional Patent Application No. 63/396,349 filed on Aug. 9, 2022. The content of which is incorporated by reference herein in their entirety.

### TECHNICAL FIELD

The present disclosure relates to a communication method used in a mobile communication system.

### BACKGROUND

The 3rd Generation Partnership Project (3GPP) has defined the technical specifications of New Radio (NR) that is radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR (for example, see Non-Patent Document 1).

### CITATION LIST

### Non-Patent Literature

Non-Patent Document 1: 3GPP Technical Specification: TS 38.300 V17.1.0

### SUMMARY

In a first aspect, a communication method is used in a mobile communication system that provides a multicast/broadcast service (MBS), the communication method including the steps of: receiving, by a user equipment in a radio resource control (RRC) connected state, a multicast session from a network; and transmitting, by the user equipment, a message to the network, the message including first information indicating that the user equipment desires to transition to an RRC inactive state and second information regarding continuation of reception of the multicast session.

In a second aspect, a communication method is used in a mobile communication system that provides a multicast/broadcast service (MBS), the communication method including the steps of: receiving, by a user equipment in a radio resource control (RRC) connected state, one or more multicast sessions from a network by using respective MBS configurations of the one or more multicast sessions; and receiving, by the user equipment from the network, an RRC release message for causing the user equipment to transition to an RRC inactive state. The RRC release message includes information indicating a multicast session to which the MBS configuration is continuously applied.

In a third aspect, a communication method is used in a mobile communication system that provides a multicast/broadcast service (IBS), the communication method including the steps of: receiving, by a user equipment in a radio resource control (RRC) inactive state, a multicast session from a network by using an MBS configuration of the multicast session; and discarding, by the user equipment, the IBS configuration in response to cell reselection performed in the RRC inactive state or a transition from the RRC inactive state to an RRC idle state.

In a fourth aspect, a communication method is used in a mobile communication system that provides a multicast/broadcast service (MBS), the communication method including the steps of: receiving, by a user equipment in a radio resource control (RRC) inactive state, a multicast session from a network by using an MBS configuration of the multicast session; discarding, by the user equipment, the MBS configuration; and initiating, by the user equipment, an RRC connection resume procedure based on the discarding of the MBS configuration.

In a fifth aspect, a communication method is used in a mobile communication system providing a multicast/broadcast service (MBS), the communication method including the steps of: receiving, by a user equipment in a radio resource control (RRC) inactive state, a multicast session from a network by using an MBS configuration of the multicast session; initiating, by the user equipment, an RRC connection resume procedure; and transmitting, by the user equipment, an RRC resume request message to the network in the RRC connection resume procedure. The RRC resume request message includes information for requesting update of the MBS configuration or information for requesting handover of the user equipment.

In a sixth aspect, a communication method is used in a mobile communication system providing a multicast/broadcast service (MBS), the communication method including the steps of: receiving, by a user equipment in a radio resource control (RRC) inactive state, a multicast session from a network by using an MBS configuration of the multicast session; managing, by the user equipment, a timer that determines a validity period of the MBS configuration; receiving, by the user equipment, a notification from the network, the notification indicating an extension of the validity period; and operating, by the user equipment, the timer to extend the validity period.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for explaining an MRB configuration (MRB-ToAddMod) defined in the technical specifications (TS38.331) of RRC.

FIGS. 7A and 7B are diagrams for describing an overview of operations according to an embodiment.

FIG. 8 is a diagram for explaining preferred RRC-State defined in the technical specifications (TS38.331) of RRC.

FIG. 9 is a flowchart illustrating operation pattern 1 according to an embodiment.

FIG. 10 is a flowchart illustrating operation pattern 2 according to an embodiment.

FIG. 11 is a diagram for explaining operation pattern 3 according to an embodiment.

FIG. 12 is a flowchart illustrating an example of the operation pattern 3 according to an embodiment.

FIG. 13 is a flowchart illustrating another example of the operation pattern 3 according to an embodiment.

FIG. 14 is a flowchart illustrating operation pattern 4 according to an embodiment.

FIG. 15 is a flowchart illustrating operation pattern 5 according to an embodiment.

FIG. 16 is a flowchart illustrating operation pattern 6 according to an embodiment.

FIG. 17 is a flowchart illustrating operation pattern 7 according to an embodiment.

### DESCRIPTION OF EMBODIMENTS

A mobile communication system according to an embodiment is described with reference to the drawings. In the description of the drawings, the same or similar parts are denoted by the same or similar reference signs.

### (1) Configuration of Mobile Communication System

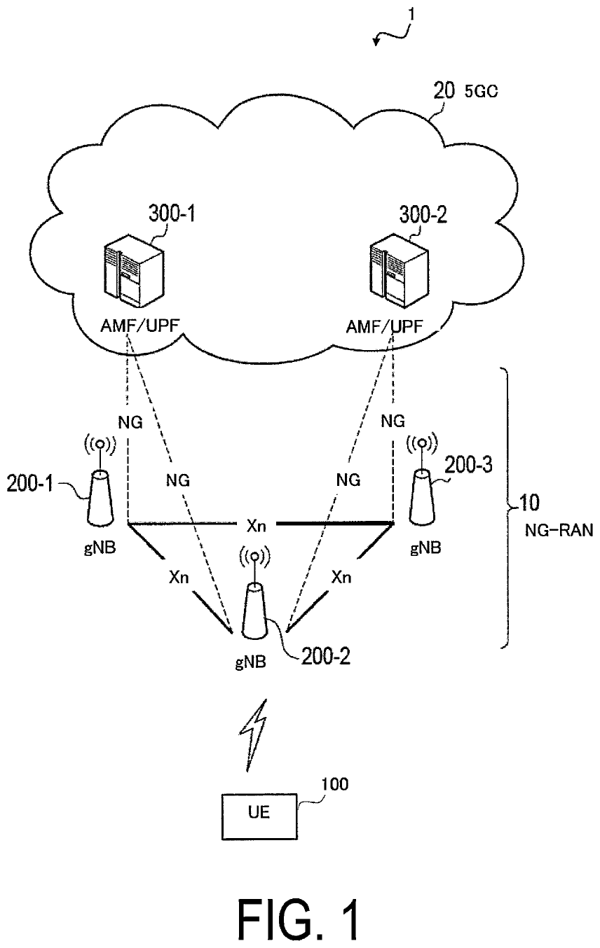

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10 (a network 10). The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

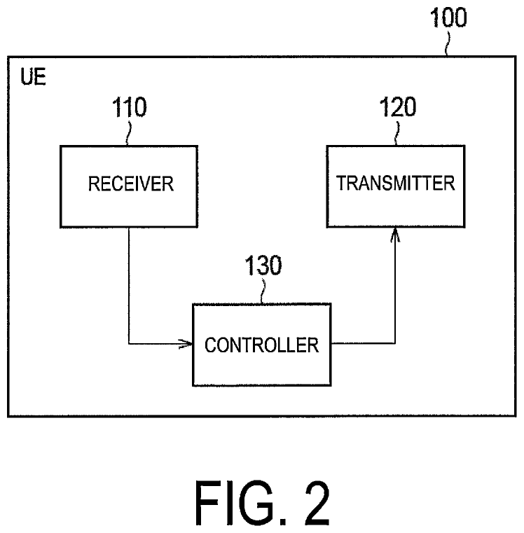

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

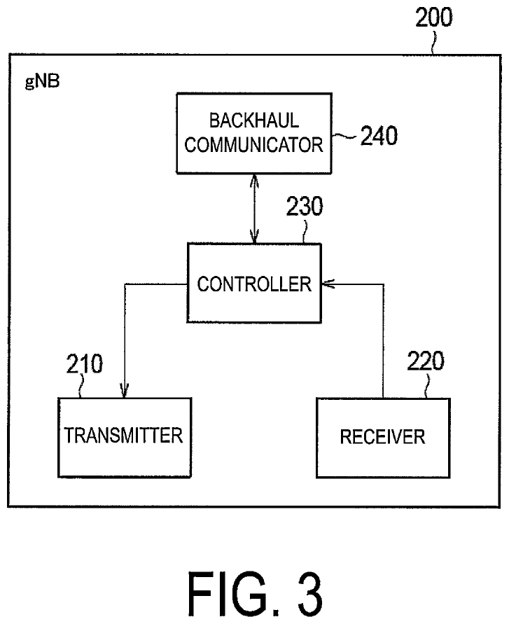

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

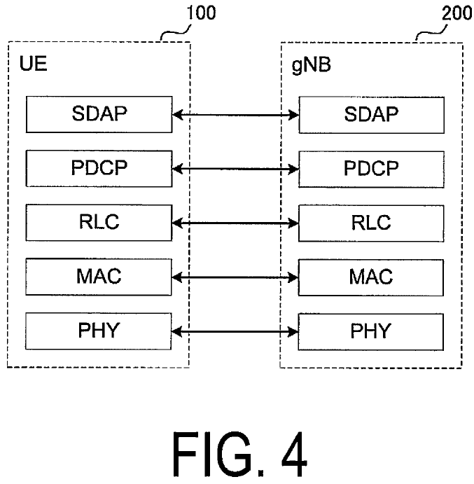

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

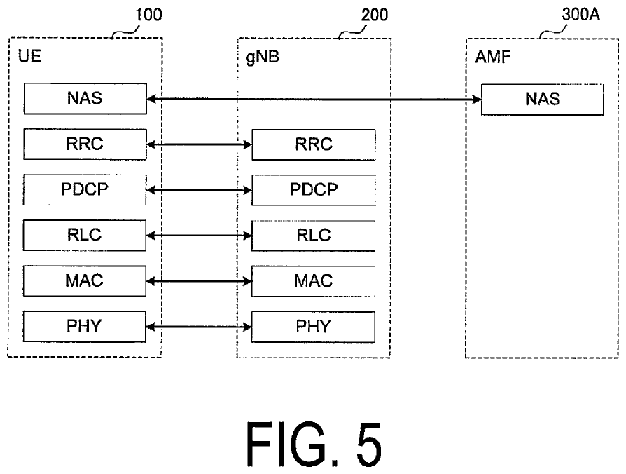

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (2) Overview of MBS

The mobile communication system 1 can perform delivery with high resource efficiency by using the multicast/broadcast service (MBS).

In the broadcast communication services (also referred to as “MBS broadcast”), the same service and the same specific content data are provided simultaneously to every UE 100 within a geographic area. That is, every UE 100 in the broadcast service area is allowed to receive the data. The broadcast communication services are delivered to the UE 100 using a broadcast session, which is a type of MBS session. The UE 100 can receive the broadcast communication services in any state of the RRC idle state, the RRC inactive state, and the RRC connected state. Such a delivery mode is also referred to as “delivery mode 1”.

In a multicast communication service (also referred to as “MBS multicast”), the same service and the same specific content data are simultaneously provided to a specific UE set. That is, not every UE 100 in the multicast service area is allowed to receive data. The multicast communication services are delivered to the UE 100 using a multicast session, which is a type of MBS session. The UE 100 can receive the multicast communication services in the RRC connected state using mechanisms such as Point-to-Point (PTP) and/or Point-to-Multipoint (PTM) delivery. The UE 100 may receive the multicast communication services in the RRC inactive (or RRC idle) state. Such a delivery mode is also referred to as “delivery mode 2”.

Main logical channels used for MBS delivery are a multicast traffic channel (MTCH), a dedicated traffic channel (DTCH), and a multicast control channel (MCCH). The MTCH is a PTM downlink channel for transmitting MBS data of either a multicast session or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100.

Regarding a configuration in MBS broadcast, the UE 100 in the RRC idle state, the RRC inactive state, or the RRC connected state receives an MBS configuration for a broadcast session (e.g., parameters required for MTCH reception) via the MCCH. Parameters required for reception of the MCCH (MCCH configuration) are provided through system information. In particular, system information block type 20 (SIB 20) includes the MCCH configuration. Note that SIB type 21 (SIB 21) includes information related to service continuity of MBS broadcast reception. The MCCH provides a list of all broadcast services including ongoing sessions transmitted on the MTCH, and the related information of the broadcast session includes an MBS session ID (e.g., Temporary Mobile Group Identity (TMGI)), related G-RNTI scheduling information, and information regarding neighboring cells providing a specific service on the MTCH.

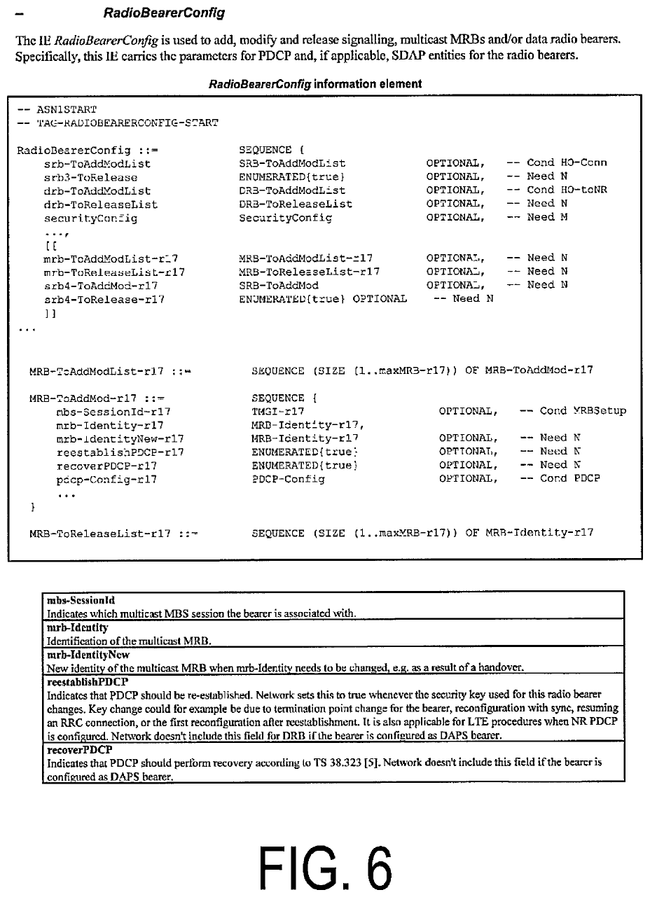

On the other hand, with respect to MBS multicast, the current technical specifications of the 3GPP enable the UE 100 to receive data of multicast sessions only in RRC connected state. When the UE 100 joining a multicast session is in the RRC connected state and the multicast session is activated, the gNB 200 transmits an RRC reconfiguration message including an MBS configuration related to the multicast session to the UE 100. Such an MBS configuration is also referred to as a multicast radio bearer (MRB) configuration, an MTCH configuration, or a multicast configuration. FIG. 6 is a diagram for explaining an MRB configuration (MRB-ToAddMod) defined in the technical specifications (TS38.331) of RRC.

The MRB configuration (MRB-ToAddMod) includes an MBS session ID (mbs-SessionId), an MRB ID (mrb-Identity), and other parameters such as a PDCP configuration (pdcp-Config) for an MRB (multicast MRB) to be configured in the UE 100.

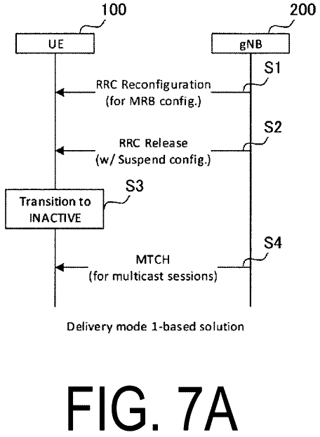

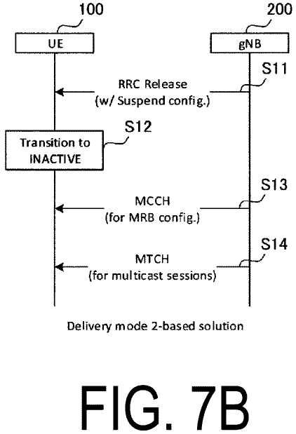

In the following embodiment, an operation of enabling the UE 100 in the RRC inactive state to perform multicast reception will be mainly described. FIGS. 7A and 7B are diagrams illustrating an overview of the operation.

As a solution for the UE 100 in the RRC inactive state to perform multicast reception, a solution based on the delivery mode 1 shown in FIG. 6A and a solution based on the delivery mode 2 shown in FIG. 7B are considered.

In the solution based on the delivery mode 1 shown in FIG. 7A, the gNB 200 transmits an RRC reconfiguration message including an MBS configuration related to the multicast session to the UE 100 in the RRC connected state in step S1. The LIE 100 receives the multicast data on the MTCH of the multicast MRB (the multicast session) based on the RRC reconfiguration message.

In step S2, the gNB 200 transmits an RRC release (Release) message for causing the LIE 100 to transition to the RRC inactive state to the LIE 100 in the RRC connected state. The RRC release message includes a configuration (Suspend Config.) for the RRC inactive state.

In step S3, the LIE 100 transitions to the RRC inactive (INACTIVE) state in response to the reception of the RRC release message in step S2.

In step S4, the LIE 100 in the RRC inactive state continues using the MBS configuration of step S1 to receive the multicast data of the multicast MRB (the multicast sessions) on the MTCH.

This enables the UE 100 in the RRC inactive state to perform multicast reception. Note that, although an example in which the multicast configuration is performed using the RRC reconfiguration message has been described, multicast configuration may be performed using an RRC release message.

On the other hand, in the solution based on the delivery mode 2 shown in FIG. 7B, the gNB 200 transmits an RRC release message for causing the UE 100 to transition to the RRC inactive state to the LIE 100 in the RRC connected state in step S11. The RRC release message includes a configuration (Suspend Config.) for the RRC inactive state.

In step S12, the LIE 100 transitions to the RRC inactive (INACTIVE) state in response to the reception of the RRC release message in step S11.

In step S13, the gNB 200 transmits the MCCH including the MBS configuration for the multicast session. The UE 100 receives the MCCH.

In step S14, the LIE 100 in the RRC inactive state receives the multicast data of the multicast MRB (the multicast session) on the MTCH based on the MCCH (NMBS configuration) of step S13. This enables the LIE 100 in the RRC inactive state to perform multicast reception.

With respect to the following operation pattern of the embodiment, improvement in the solution based on the delivery mode 1 as described above will be described.

### (3) Operation Pattern 1

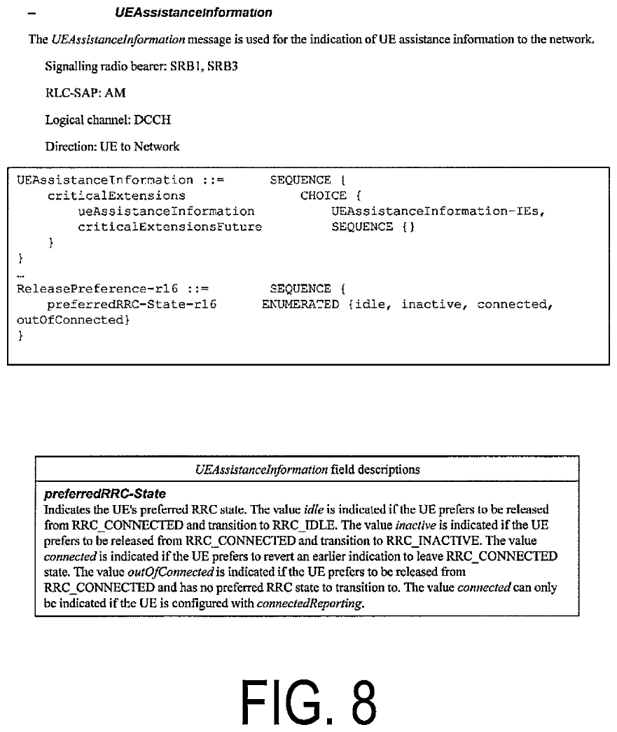

The UE 100 of the RRC connected state can notify the network of the RRC state that the LIE 100 desires using a LIE assistance information message. FIG. 8 is a diagram for explaining preferred RRC-State defined in the technical specifications (TS38.331) of RRC.

The LIE assistance information message transmitted from the LIE 100 to the network 10 can include preferred RRC-State as an information component. The LIE 100 notifies the gNB 200 of its own preferred RRC state, to be more specific, any one of an RRC connected state, an RRC inactive state, an RRC idle state, and a non-RRC connected state (outOfConnected) in accordance with, for example, a unicast communication state.

Here, when the LIE 100 that performs multicast reception transmits, to the network 10 (gNB 2 00), preferred RRC-State indicating that transition to the RRC inactive state is desired, it is assumed that the gNB 200 causes the LIE 100 to transition to the RRC inactive state. However, if the gNB 200 simply causes the LIE 100 to transition to the RRC inactive state, the LIE 100 may not continue the multicast reception.

In the present operation pattern, the LIE 100 that receives the multicast session from the network 10 in the RRC connected state transmits a message including first information indicating that the transition to the RRC inactive state is desired and second information regarding continuation of the reception of the multicast session to the network 10. For example, when transmitting, to the gNB 200, the LIE assistance information message including the preferred RRC-State (first information) indicating that a transition to the RRC inactive state is desired, the LIE 100 includes the second information regarding continuation of the reception of the multicast session in the UE assistance information message. This enables the gNB 200 to appropriately apply the configuration for performing multicast reception in the RRC inactive state to the UE 100.

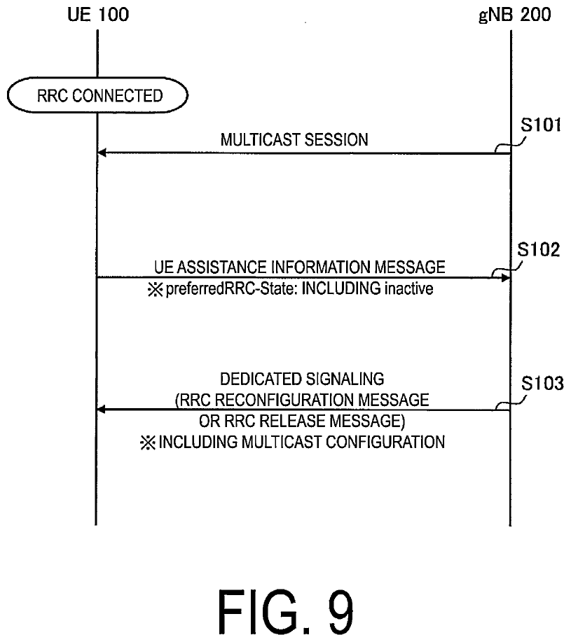

FIG. 9 is a flowchart illustrating operation pattern 1 according to an embodiment. In the description of the present operation pattern, the same operations as those shown in FIGS. 7A and 7B, particularly FIG. 7A, will not be described. In the present operation pattern and operation patterns to be described below, it is assumed that a UE 100 joining a multicast session receives an MBS configuration (multicast configuration) related to the multicast session from the network 10 (gNB 200).

In step S101, the UE 100 performs multicast reception in the RRC connected state. Here, the UE 100 determines whether a transition to the RRC inactive state is possible. For example, the UE 100 determines that a transition to the RRC inactive state is possible when at least one selected from the group consisting of the conditions that there will be no unicast communication (in the near future), the condition that the UE 100 itself has the capability of continuing multicast reception in the RRC inactive state, and the condition that there will be no data transmission regarding multicast (in the near future) is satisfied.

In step S102, the UE 100 transmits, to the gNB 200, a UE assistance information message including preferred RRC-State (first information) indicating that the UE 100 wishes to transition to the RRC inactive state. The gNB 200 receives the UE assistance information message. Here, the UE 100 includes information indicating the necessity of the multicast reception configuration in the UE assistance information message as the second information regarding continuation of the reception of the multicast session. The second information may be information elements included in ReleasePreference. For example, the second information may be information indicating that continuation of multicast reception is desired. The second information may be an MBS session ID (TMGI) with which the UE 100 wishes to continue multicast reception and/or an MBS bearer ID (MRB ID) with which the UE 100 wishes to continue multicast reception.

In step S103, the gNB 200 transmits dedicated signaling including a multicast configuration (MRB/MTCH configuration) related to multicast reception for the RRC inactive state to the UE 100 based on the message in step S102. For example, the gNB 200 transmits an RRC release message for causing the UE 100 to transition to the RRC inactive state to the UE 100 after transmitting an RRC reconfiguration message including the MBS configuration to the UE 100. The gNB 200 may transmit an RRC release message including the MBS configuration to the UE 100. Here, the multicast configuration for the RRC inactive state may be different from the multicast configuration for the RRC connected state. The multicast configuration may be the same as the multicast configuration for the RRC connected state. In the same case, the gNB 200 may instruct the UE 100 to continue applying the multicast configuration for the current RRC connected state in the RRC inactive state.

Although the solution based on the delivery mode 1 has been described in the present operation pattern, in the case of the solution based on the delivery mode 2, the gNB 200 updates the MCCH to perform the MRB configuration and causes the UE 100 to transition to the RRC inactive state.

Although an example of using the UE assistance information message has been described in the present operation pattern, another message, for example, an MBS interest indication message may be used instead of the UE assistance information message. A response message to a query from the gNB 200 may be used instead of the UE assistance information message. For example, when detecting network congestion, the gNB 200 may query the UE 100 whether the UE 100 can transition to the RRC inactive state.

### (4) Operation Pattern 2

Differences of operation pattern 2 from the operation described above will be mainly described. The present operation pattern can be implemented in combination with the above-described operation.

In the present operation pattern, the UE 100 in the RRC connected state receives one or more multicast sessions from the network 10 (gNB 200) using the MBS configurations of each of the one or more multicast sessions. The UE 100 receives the RRC release message for causing the UE 100 to transition to the RRC inactive state from the network 10. The RRC release message includes information indicating a multicast session to which the MBS configuration (multicast configuration) is continuously applied. Thus, based on the information, the UE 100 can apply the new multicast configuration to another multicast session (MRB) while using the already configured multicast configuration without change for some multicast sessions (MRBs).

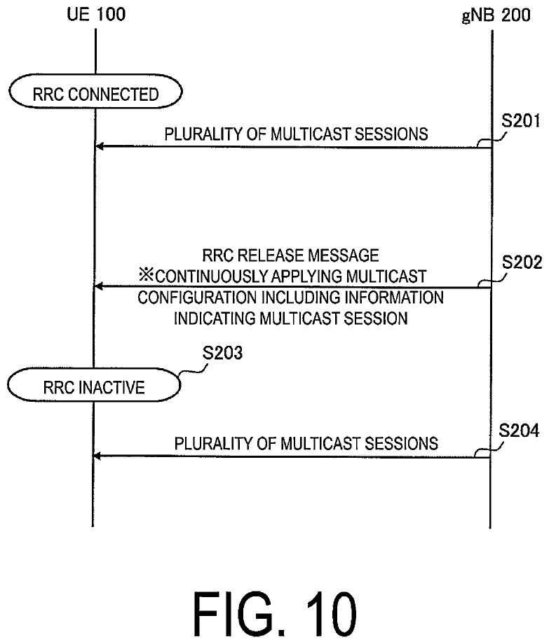

FIG. 10 is a diagram illustrating the operation pattern 2 according to an embodiment. In the description of the present operation pattern, the description of the same operation as that described above will not be repeated.

In step S201, the UE 100 is receiving a plurality of multicast sessions in the RRC connected state. Here, the gNB 200 determines to cause the UE 100 in the middle of multicast reception to transition to the RRC inactive state. At that time, the gNB 200 checks the MRB configurations (multicast configurations) for the plurality of multicast sessions that the UE 100 is receiving.

In step S202, the gNB 200 transmits, to the UE 100, an RRC release message including information (e.g., a list) indicating whether the already configured multicast configuration can be applied for each MRB ID or for each MBS session ID. The RRC release message may include information indicating that the already configured multicast configuration for the RRC connected state associated with the MRB ID or the MBS session ID is diverted (i.e., continuously applied even after the transition to the RRC inactive state). The RRC release message may include a new multicast configuration (i.e., a multicast configuration to be applied after the transition to the RRC inactive state) associated with the MRB ID or the MBS session ID. When there is no new multicast configuration (NULL value), it may be implicitly indicated that the application of the already configured multicast configuration is continued.

In step S203, the UE 100 transitions to the RRC inactive state in response to the reception of the RRC release message in step S202.

In step S204, the UE 100 selectively applies, for each multicast session (MRB), the already configured multicast configuration for the RRC connected state or the new multicast configuration in accordance with the information included in the RRC release message, and continues the reception of the multicast sessions (MRB).

### (5) Operation Pattern 3

Differences of operation pattern 3 from the operations described above will be mainly described. The present operation pattern can be implemented in combination with the above-described operations. The present operation pattern is an operation pattern focusing on cell reselection performed after the UE 100 transitions to the RRC inactive state.

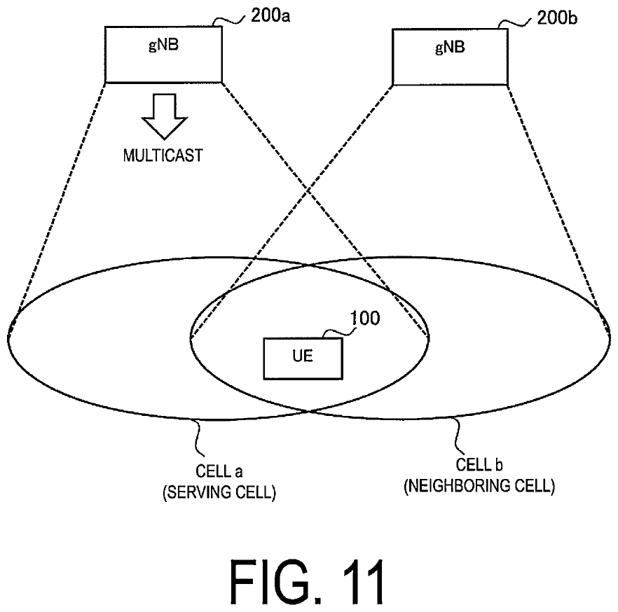

FIG. 11 is a diagram for explaining the operation pattern 3 according to an embodiment. In the illustrated example, a gNB 200a manages a cell a and a gNB 200b manages a cell b. The UE 100 performs multicast reception in the cell a (gNB 200a) in the RRC inactive state using the multicast configuration received in the cell a (gNB 200a). The multicast configuration received in the cell a (gNB 200a) may be valid only in the cell a. The multicast configuration received in the cell a (gNB 200a) may be valid only within a predetermined area range including the cell a.

In the illustrated example, it is assumed that the multicast configuration received in the cell a (gNB 200a) is not valid in the cell b. Under such an assumption, the UE 100 discards the multicast configuration in response to performing cell reselection from the cell a to the cell b in the RRC inactive state.

When the UE 100 leaves the cell a and moves out of range, the UE 100 transitions from the RRC inactive state to the RRC idle state. Under such an assumption, the UE 100 may discard the multicast configuration in accordance with the transition from the RRC inactive state to the RRC idle state.

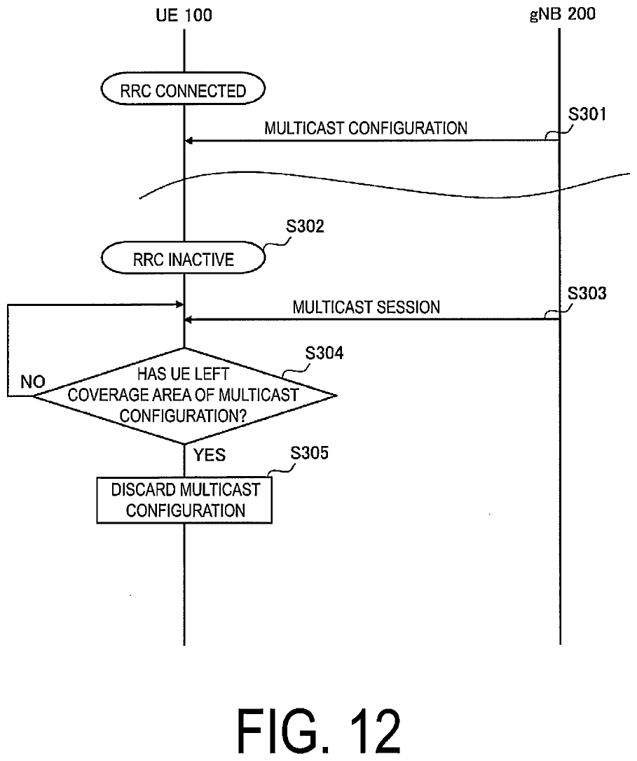

FIG. 12 is a flowchart illustrating an example of the operation pattern 3 according to an embodiment. In the description of the present operation pattern, the description of the same operation as that described above will not be repeated.

In step S301, the UE 100 in the RRC connected state receives a multicast configuration for the RRC inactive state from the network 10 (gNB 200) by dedicated signaling (RRC reconfiguration message or RRC release message) and starts reception of a multicast session. The gNB 200 may transmit information for configuring a coverage area of the multicast configuration to the UE 100. The information may be a list of IDs of the cells constituting the coverage area. The information may be information for designating a Registration Area (RA), a Tracking Area (TA), or an RAN Notification Area (RNA) as the coverage area. If the multicast configuration is valid only in the current serving cell, the information is not needed.

After that, the UE 100 transitions to the RRC inactive state in step S302.

In step S303, the UE 100 in the RRC inactive state performs multicast reception using the multicast configuration of step S351.

In step S304, the UE 100 in the RRC inactive state determines whether the UE 100 itself has left the coverage area (serving cell, RA, TA, or RNA) of the multicast configuration of step S301. To be specific, the UE 100 may determine whether cell reselection with respect to a cell outside the coverage area has been performed.

When cell reselection with respect to a cell outside the coverage area is performed (step S304: YES), the UE 100 discards the currently applied multicast configuration in step S305. Note that, an example of the operation after the multicast configuration is discarded will be described below.

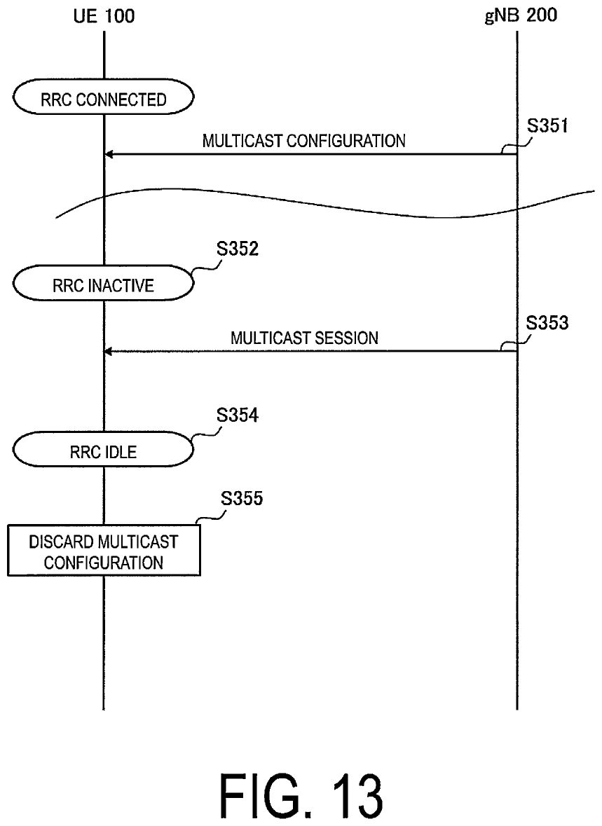

FIG. 13 is a flowchart illustrating another example of the operation pattern 3 according to an embodiment.

In step S351, the UE 100 in the RRC connected state receives a multicast configuration for the RRC inactive state from the network 10 (gNB 200) by dedicated signaling (RRC reconfiguration message or RRC release message) and starts reception of a multicast session.

After that, the UE 100 transitions to the RRC inactive state in step S352.

In step S353, the UE 100 in the RRC inactive state performs multicast reception using the multicast configuration of step S351.

In step S354, the UE 100 in the RRC inactive state transitions to the RRC idle state. For example, the UE 100 transitions to the RRC idle state by moving out of range.

In step S355, in response to the transition to the RRC idle state, the UE 100 discards the applied multicast configuration and stops the multicast reception (MTCH reception). The UE 100 may deactivate (suspend) the multicast configuration and stop the multicast reception (MTCH reception) without discarding the multicast configuration.

### (6) Operation Pattern 4

Differences of operation pattern 4 from the operations described above will be mainly described. The present operation pattern can be implemented in combination with the above-described operations.

As described above, the UE 100 discards the multicast configuration for the reason that the UE 100 has left the coverage area of the multicast configuration or the like. When a validity period has been set for the multicast configuration, the UE 100 may discard the multicast configuration in accordance with the expiration of the validity period.

In the present operation pattern, the UE 100 in the RRC inactive state receives a multicast session from the network 10 using the MBS configuration (multicast configuration) of the multicast session. The UE 100 initiates an RRC connection resume procedure based on the discarding of the multicast configuration. As a result, the UE 100 can acquire a new multicast configuration from the network 10, and thus can resume multicast reception.

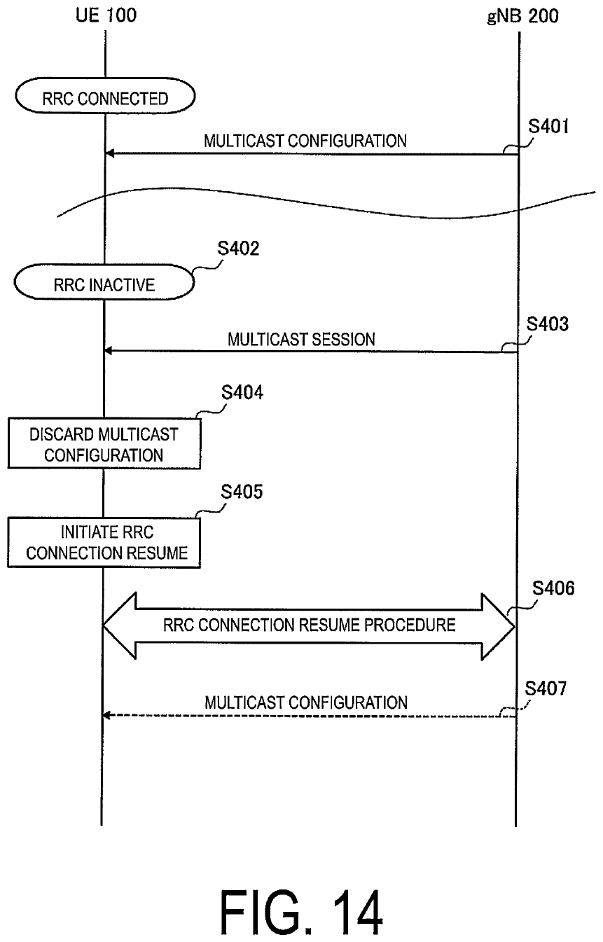

FIG. 14 is a flowchart illustrating the operation pattern 4 according to an embodiment. In the description of the present operation pattern, the description of the same operation as that described above will not be repeated.

In step S401, the UE 100 in the RRC connected state receives a multicast configuration for the RRC inactive state from the network 10 (gNB 200) by dedicated signaling (RRC reconfiguration message or RRC release message) and starts reception of a multicast session.

After that, the UE 100 transitions to the RRC inactive state in step S402.

In step S403, the UE 100 in the RRC inactive state performs multicast reception using the multicast configuration of step S401.

In step S404, the UE 100 discards the multicast configuration. As described above, the UE 100 may perform cell reselection and discard the multicast configuration since the UE 100 has left the coverage area (cell). When a timer value (that is, a validity period of the multicast configuration) has been set in the RRC release message and the timer is started when the UE 100 transitions to the RRC inactive state, the UE 100 may discard the multicast configuration in response to the expiration of the timer (that is, the expiration of the validity period).

In step S405, the UE 100 initiates RRC connection resume. Here, the AS of the UE 100 (for example, RRC) may notify its own upper layer (NAS) that the multicast configuration has been discarded or multicast reception cannot be continued. This notification may include an MBS session ID (TMGI) or an MRB ID. The upper layer of the UE 100 may request the AS to perform the RRC connection resume procedure in response to the notification. The AS may autonomously initiate the RRC connection resume procedure to acquire a new multicast configuration.

In step S406, the UE 100 performs an RRC connection resume procedure with respect to the network 10 (gNB 200). Thia procedure includes a random access procedure in which an RRC resume request (Resume Request) message may be transmitted from the UE 100 to the network 10 (gNB 200). As a result, in step S407, the UE 100 may acquire a new multicast configuration from the network 10 (gNB 200). Such selection processing will be described in detail later.

### (7) Operation Pattern 5

Differences of operation pattern 5 from the operations described above will be mainly described. The present operation pattern can be implemented in combination with the above-described operations.

As described above, the UE 100 can transition to the RRC connected state through the RRC connection resume procedure and can acquire a new multicast configuration from the network 10 (gNB 200). Here, by returning to the RRC inactive state immediately after the UE 100 acquires the new multicast configuration, an increase in power consumption of the UE 100 and a network load can be curbed.

In the present operation pattern, when the UE 100 transmits an RRC resume request (Resume Request) message to the network 10 (gNB 200) in the RRC connection resume procedure, the RRC resume request message includes information for requesting update of the MBS configuration (multicast configuration). As a result, the network 10 (gNB 200) can provide a new multicast configuration to the UE 100 at an early stage based on the RRC resume request message.

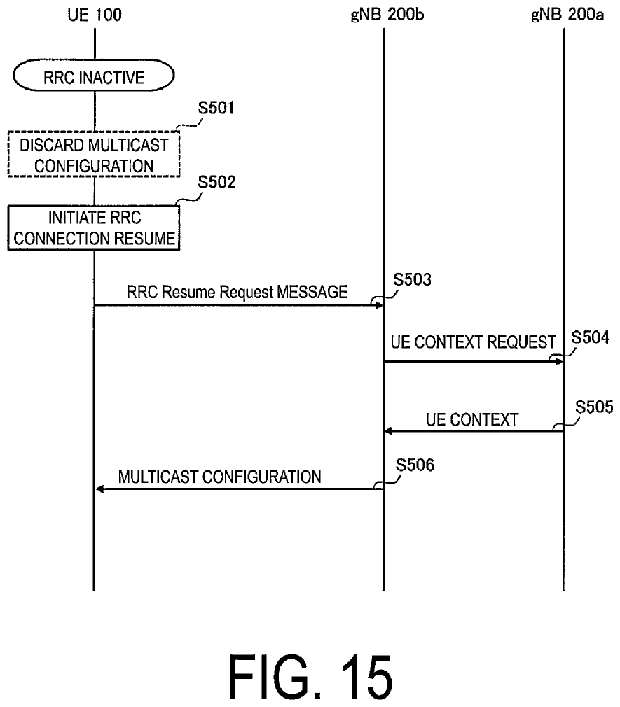

FIG. 15 is a flowchart illustrating operation pattern 5 according to an embodiment. In the description of the present operation pattern, the description of the same operation as that described above will not be repeated. In the illustrated example, it is assumed that the UE 100 in the RRC inactive state performs cell reselection from the cell a within the coverage area of the multicast configuration to the cell b outside the coverage area in the scenario illustrated in FIG. 11.

In step S501, the UE 100 that performs multicast reception in the RRC inactive state may discard (or detect that the UE 100 will discard, in the near future) the multicast configuration as described above.

In step S502, the UE 100 initiates an RRC connection resume procedure.

In step S503, the UE 100 transmits an RRC resume request message to the cell b (gNB 200b). The gNB 200b receives the RRC resume request message. The RRC resume request message includes an information element “Resume Cause” indicating the reason for RRC resume and an Inactive RNTI (I-RNTI). Here, the UE 100 sets Resume Cause to “multicast configuration update”, for example, “multicast-configuration-update”. The UE 100 may set information indicating a desire to continue multicast reception in the RRC inactive state as the Resume Cause. The UE 100 may include an identifier (such as a TMGI and/or an MRB ID) indicating the multicast session whose configuration is to be updated in the RRC resume request message.

In step S504, the gNB 200b may identify the gNB 200a carrying the context of the UE 100 based on the I-RNTI included in the RRC resume request message of step S503, and request the context of the UE 100 on the Xn interface. As a result, the gNB 200b acquires the context of the UE 100 from the gNB 200a. The gNB 200b may request and acquire only the MBS-related context among the context of the UE 100. The gNB 200b may identify a multicast session (TMGI) that the UE 100 is receiving from the context of the UE 100. The gNB 200b derives, from the context of the UE 100, a new multicast configuration to be configured for the UE 100. The gNB 200b may notify the gNB 200a of the new multicast configuration (MBS-related context). The gNB 200a may update the context of the UE 100 in accordance with the notification.

In step S506, the gNB 200b transmits the new multicast configuration to the UE 100. The UE 100 receives the new multicast configuration. The gNB 200b may transmit an RRC release message including the new multicast configuration as a response to the RRC resume request message. In this case, the UE 100 may acquire the new multicast configuration without transitioning to the RRC connected state. The gNB 200b may cause the UE 100 to transition to the RRC connected state, perform multicast configuration with the RRC reconfiguration message, and then transmit the RRC release message to the UE 100. As a result, the UE 100 transitions to the RRC inactive state.

### (8) Operation Pattern 6

Differences of operation pattern 6 from the operations described above will be mainly described. The present operation pattern can be implemented in combination with the above-described operations.

As described above, when the UE 100 in the RRC inactive state performs cell reselection with the multicast configuration being valid in the coverage area (for example, only within the cell in which the multicast configuration has been performed), the multicast configuration becomes unavailable. Therefore, multicast reception cannot be continued. In the operation pattern 5 described above, a new multicast configuration is acquired when the UE 100 leaves the coverage area (i.e., after cell reselection). On the other hand, in the present operation pattern, it is assumed that the UE 100 transitions to the RRC connected state before the UE 100 leaves the coverage area (i.e., before cell reselection), and thereby the UE 100 is handed over to the target cell.

In the present operation pattern, when the UE 100 transmits an RRC resume request (Resume Request) message to the network 10 (gNB 200) in the RRC connection resume procedure, the RRC resume request message includes information for requesting handover. As a result, the network 10 (gNB 200) can appropriately hand over the UE 100 in response to the RRC resume request message. It is also possible to provide the UE 100 with a new multicast configuration during the handover procedure.

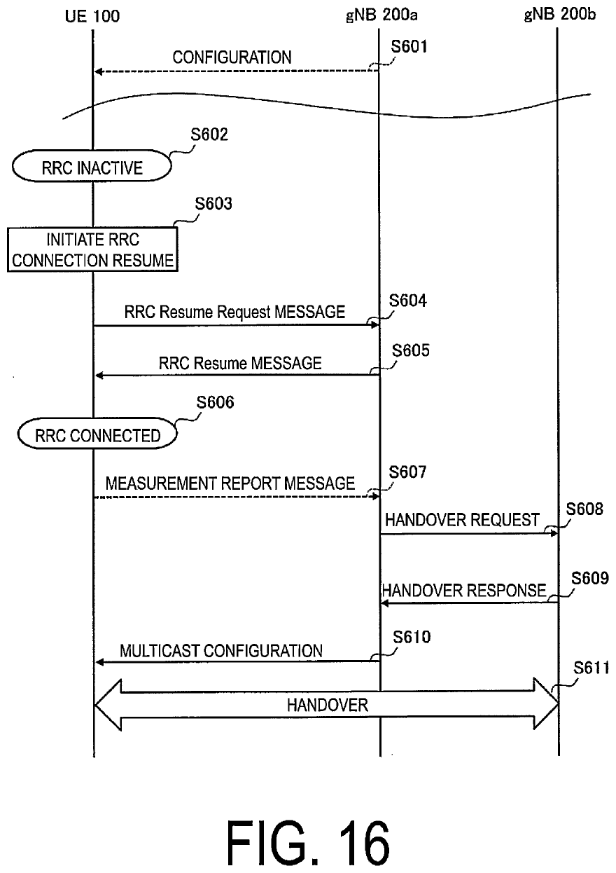

FIG. 16 is a flowchart illustrating the operation pattern 6 according to an embodiment. In the description of the present operation pattern, the description of the same operation as that described above will not be repeated. In the illustrated example, it is assumed that the UE 100 in the RRC inactive state performs the RRC connection resume procedure for the cell a before performing cell reselection from the cell a within the coverage area of the multicast configuration to the cell b outside the coverage area in the scenario illustrated in FIG. 11.

In step S601, the gNB 200a may configure the UE 100 to transition to the RRC connected state before leaving the coverage area of the multicast configuration (for example, before cell reselection). For example, the gNB 200a may perform the configuration for a multicast session having strict service requirements for multicast reception interruption. The configuration may be applied while the UE 100 is in the RRC connected state.

Thereafter, in step S602, the UE 100 transitions to the RRC inactive state and continues multicast reception.

In step S603, the UE 100 initiates an RRC connection resume procedure for the cell a (gNB 200a) upon recognizing that the UE 100 is outside the coverage area of the multicast configuration (e.g., the cell a).

In step S604, the UE 100 transmits an RRC resume request message to the gNB 200a. The gNB 200a receives the RRC resume request message. The message includes, as Resume Cause, information indicating that handover for continuing multicast reception is requested. The information may be information indicating that only handover is desired. The gNB 200a desirably accepts the access based on the Resume Cause since access for only performing the handover little affects the load.

In step S605, the gNB 200a transmits an RRC resume message to the UE 100. The UE 100 receives the RRC resume message and transitions to the RRC connected state (step S606).

In step S607, the UE 100 may transmit a measurement report message including the measurement result (for example, RSRP/RSRQ for each cell) in the RRC inactive state and/or the cell ID of the cell b which is the target cell (candidate cell) to the gNB 200a. The UE 100 may include the information in the RRC resume request message of step S604.

In step S608, the gNB 200a transmits a handover request message to the gNB 200b over the Xn interface. The handover request message may include the context of the UE 100.

In step S609, the gNB 200b transmits a handover response message to the gNB 200a over the Xn interface. The handover response message may include a new multicast configuration to configure for the UE 100.

In step S610, the gNB 200a transmits a handover command (RRC reconfiguration message) including the new multicast configuration to the UE 100.

In step S611, the UE 100 applies the new multicast configuration, accesses the cell b (gNB 200b) which is the target cell, and starts (resumes) multicast reception.

### (9) Operation Pattern 7

Differences of operation pattern 7 from the operations described above will be mainly described. The present operation pattern can be implemented in combination with the above-described operations.

As described above, the network 10 (gNB 200) may configure the validity period (timer) of the multicast configuration for the RRC inactive state to the UE 100. The UE 100 discards the multicast configuration when the timer expires. However, when there is no need to change the multicast configuration, continuous use of the multicast configuration is efficient even if the timer is set. In the present operation example, the validity period can be extended through signaling from the network 10 (gNB 200).

That is, in this operation example, the UE 100 that receives a multicast session using an MBS configuration (multicast configuration) in the RRC inactive state manages a timer that determines a validity period of the multicast configuration (hereinafter also referred to as a “discard timer”). Upon receiving a notification indicating an extension of the validity period from the network 10, the UE 100 operates the timer to extend the validity period.

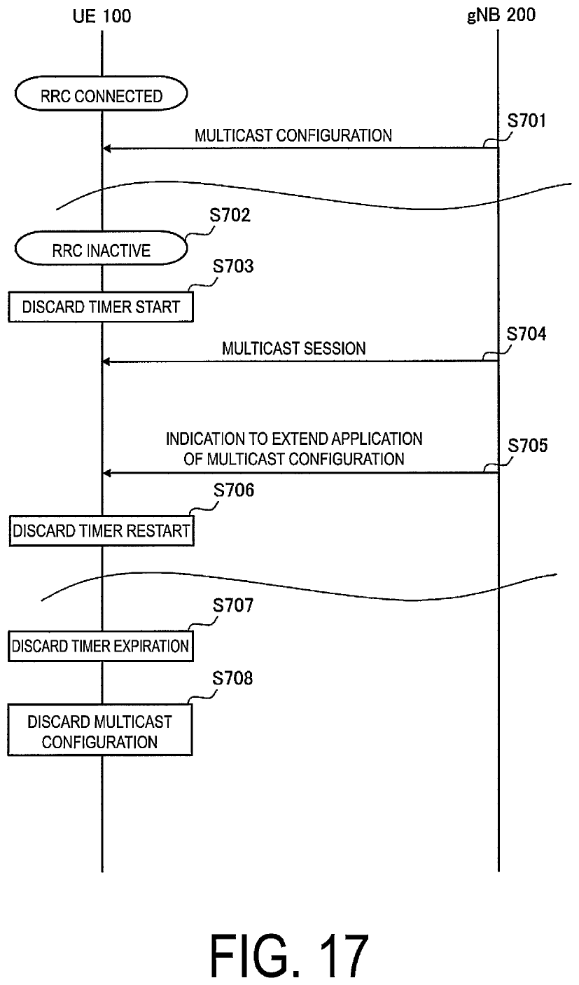

FIG. 17 is a flowchart illustrating the operation pattern 7 according to an embodiment. In the description of the present operation pattern, the description of the same operation as that described above will not be repeated.

In step S701, the UE 100 receives a multicast configuration in dedicated signaling (RRC reconfiguration message or RRC release message) from the network 10 (gNB 200). The configuration may include a set value for the discard timer. When the UE 100 receives multiple multicast sessions, the discard timer may be set individually for each multicast session.

After that, the UE 100 transitions to the RRC inactive state in step S702.

In step S703, the UE 100 starts the discard timer upon transitioning to the RRC inactive state. The UE 100 may start the timer upon receiving an RRC release message or upon receiving an RRC reconfiguration message.

In step S704, the UE 100 performs multicast reception using the multicast configuration of step S701 while the discard timer is running.

In step S705, when there is no change in the multicast configuration, the gNB 200 notifies the UE 100 of an instruction to extend the application of the configuration. The gNB 200 may transmit the instruction periodically as long as there is no change in the multicast configuration. The UE 100 receives the notification (instruction). For example, the instruction is transmitted in broadcast signaling, such as SIB, MCCH, MAC CE multiplexed to MTCH, transmitted by the gNB 200. The instruction may include an identifier (TMGI, MRB ID, etc.) indicating a multicast session to which the instruction applies. The UE 100 may apply the instruction only to the discard timer associated with the multicast session. If the instruction does not include the identifier, the UE 100 may apply the instruction to the timers of all multicast sessions.

The instruction may be an instruction to restart the discard timer. The UE 100 may restart the discard timer immediately after receiving the instruction. The UE 100 may restart the timer when the discard timer expires after receiving the instruction. The notification (instruction) may be an instruction to update or newly set the timer value, for example, an instruction to change the timer value set to 1 minute to 10 minutes.

In step S706, the UE 100 restarts the discard timer in response to receiving the instruction of step S705. The UE 100 may update or reset the timer value of the discard timer.

When the multicast configuration needs to be changed, the gNB 200 stops notifying the instruction.

In step S707, the UE 100 detects the expiration of the discard timer.

In step S708, the UE 100 discards the multicast configuration received in step S701 in response to the expiration of the discard timer. Note that the operation after discarding the multicast configuration is the same as or similar to that in the above-described operation pattern.

### (10) Other Embodiment

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (12) First Supplementary Note

Features relating to the embodiments described above are described below as supplements.

### Supplementary Note 1

A communication method used in a mobile communication system configured to provide a multicast/broadcast service (MBS), the communication method including the steps of: receiving, by a user equipment in a radio resource control (RRC) connected state, a multicast session from a network; and
transmitting, by the user equipment, a message to the network, the message including first information indicating that the user equipment desires to transition to an RRC inactive state and second information regarding continuation of reception of the multicast session.

### Supplementary Note 2

A communication method used in a mobile communication system configured to provide a multicast/broadcast service (MBS), the communication method including the steps of: receiving, by a user equipment in a radio resource control (RRC) connected state, one or more multicast sessions from a network by using an MBS configuration of each of the one or more multicast sessions; and
receiving, by the user equipment from the network, an RRC release message for causing the user equipment to transition to an RRC inactive state,
wherein the RRC release message includes information indicating one of the multicast sessions to which the MBS configuration is continuously applied.

### Supplementary Note 3

A communication method used in a mobile communication system configured to provide a multicast/broadcast service (MBS), the communication method including the steps of:
receiving, by a user equipment in a radio resource control (RRC) inactive state, a multicast session from a network by using an MBS configuration of the multicast session; and
discarding, by the user equipment, the MBS configuration in response to cell reselection performed in the RRC inactive state or a transition from the RRC inactive state to an RRC idle state.

### Supplementary Note 4

A communication method used in a mobile communication system configured to provide a multicast/broadcast service (MBS), the communication method including the steps of:
receiving, by a user equipment in a radio resource control (RRC) inactive state, a multicast session from a network by using an MBS configuration of the multicast session;
discarding, by the user equipment, the MBS configuration; and
initiating, by the user equipment, an RRC connection resume procedure, based on the discarding of the MBS configuration.

### Supplementary Note 5

A communication method used in a mobile communication system configured to provide a multicast/broadcast service (MBS), the communication method including the steps of:
receiving, by a user equipment in a radio resource control (RRC) inactive state, a multicast session from a network by using an MBS configuration of the multicast session;
initiating, by the user equipment, an RRC connection resume procedure; and
transmitting, by the user equipment, an RRC resume request message to the network in the RRC connection resume procedure,
wherein the RRC resume request message includes information for requesting update of the MBS configuration or information for requesting handover of the user equipment.

### Supplementary Note 6

A communication method used in a mobile communication system configured to provide a multicast/broadcast service (MBS), the communication method including the steps of:
receiving, by a user equipment in a radio resource control (RRC) inactive state, a multicast session from a network by using an MBS configuration of the multicast session;
managing, by the user equipment, a timer configured to determine a validity period of the MBS configuration;
receiving, by the user equipment, a notification from the network, the notification indicating an extension of the validity period; and
operating, by the user equipment, the timer to extend the validity period.

### (13) Second Supplementary Note

### Introduction

At RAN #94e, a new work item was approved for MBS enhancement (eMBS) with a revised WID at RAN #96. One purpose of Release 18 is to allow UEs in the RRC inactive state to receive multicast sessions.

To define support for multicast reception by UEs in the RRC inactive state.
To configure PTM of a UE receiving multicast in the RRC inactive state
To investigate the impact of mobility and state transition of the UE receiving multicast in the RRC inactive state (seamless/lossless mobility is not a requirement).

In this supplementary note, the support for multicast reception in the RRC inactive state will be discussed first, taking into account the relevant discussion made in Release 17.

### Discussion

Discussion in Release 17 and directionality of solutions in Release 18 Although multicast reception in the RRC inactive state has been briefly discussed in Release 17, RAN2 decided to prioritize multicast reception only in the RRC connected state as follows. Although RAN2 did not define this function in Release 17, there are already some potential solutions, which are still good starting points for discussion of Release 18.

Chairman: RAN2 prioritizes active multicast support in the RRC connected mode in Release 17. If time permits, support for multicast in the RRC inactive state can be discussed later (when the solution for multicast and solution for broadcast in the connected mode become more mature).

The network may release a UE receiving a multicast session to be inactive, such as when the network becomes congested due to a large number of UEs in the cell. Thus, in this scenario, it is assumed that the UE is initially connected when the UE starts receiving the multicast session (including the procedure of joining the multicast session). Then, the UE is released to be inactive while continuing reception of the multicast session.

Observation 1: This scenario is that a UE receiving a multicast session in the RRC connected state is released to the RRC inactive state so that the UE can continue receiving the multicast session.

In Release 17, two delivery modes are defined, which are referred to as “delivery mode 1” for multicast sessions and “delivery mode 2” for broadcast sessions. Although the reception configuration of the MTCH is provided to the UE in the connected state through the RRC reconfiguration in the delivery mode 1, in the delivery mode 2, the reception configuration is provided to all the UEs in the RRC state through the MCCH.

In order to support multicast reception in the inactive state, whether the solution is based on “delivery mode 1” or “delivery mode 2” needs to be considered first.

Although providing multicast sessions is simple in delivery mode 1, the mode is currently limited to UEs in the connected state. In order to support UEs in the inactive state, many functions and assumption restrictions/changes, such as handling of the MTCH configuration, deactivation of PTP legs, HARQ feedback, CFR, etc., may be needed. Although RAN1 may need to be involved in those changes, note that RAN1 is not described in Rel-18eMBSWI.

Observation 2: In order to provide a multicast session, providing the reception configuration of the MTCH through dedicated signaling is direct (i.e. based on delivery mode 1). However, note that RAN1 involvement may be required, which the WG to be supported by the WID does not include.

Although delivery mode 2 already supports broadcast reception in the inactive state, the mode is less likely to be able to control a network (NW) than in a multicast session. The MCCH is likely to be received by all UEs and the reception configuration of the MTCH associated with multicast sessions is also visible to all the UEs, and thus potential security concerns exist.

Observation 3: The MCCH can provide a broadcast session for UEs that are already in the RRC inactive state (i.e. based on delivery mode 2). However, Release 17 has a problem of less control over networks.

From the above observations, since RAN 2 supports multicast reception in the RRC inactive state, the direction of the solution with respect to whether the reception configuration of the MTCH is provided through dedicated signaling (i.e., delivery mode 1-based solution) or provided by the MCCH (i.e., delivery mode 2-based solution) needs to be discussed.

Proposal 1: Since RAN 2 supports multicast reception in the RRC inactive state, the direction of the solution with respect to whether the reception configuration of the MTCH is provided through dedicated signaling (i.e., delivery mode 1-based solution) or provided by the MCCH (i.e., delivery mode 2-based solution) needs to be discussed.

### Delivery Mode 1—Based Solution

When the reception configuration of the MTCH is provided through dedicated signaling, whether the configuration is provided by RRC reconfiguration (same as or similar to Release 17) or provided by RRC release needs to be discussed.

Using RRC reconfiguration, the UE continues applying the same configuration to receive the MTCH of interest even if the UE transitions from the connected state to the inactive state. The advantage is that the current RRC reconfiguration can be reused since the MRB configuration is already defined in Release 17. On the other hand, since the UE needs to continue applying the MRB configuration even after transitioning to the inactive state, additional UE behavior needs to be defined in the RRC reconfiguration procedure. In this case, the question remains, such as whether the UE that is interested in the multicast session and has transitioned to the inactive state can continue applying the configuration at all times, or whether the network needs to explicitly indicate whether to apply the MRB configuration by RRC release, or the like. RAN2 needs to discuss whether the UE can verify the MRB configuration, in other words, whether a validity timer like T320 of dedicated priority is needed. In RRC release, when the UE transitions to the inactive state, the UE can continue receiving the MTCH of interest by simply applying a new configuration if the RRC release message has provided the configuration. In general, when the UE transitions to the RRC inactive state, it is very simple to use RRC release to provide a specific configuration to the UE. When the affinity with the RNA update procedure is high and the MRB used in the inactive state can be reconfigured even in the RNA update (i.e., RRC release), the UE can be reconfigured without transitioning to the connected state. However, a disadvantage is that signaling overhead always occurs. That is, the MRB configuration occurs even though the configuration is the same as that already provided through the RRC reconfiguration in advance. It is also worth discussing whether a validity timer is required.

Therefore, when the reception configuration of the MTCH is provided through dedicated signaling, RAN2 needs to discuss whether the configuration is provided through RRC reconfiguration or RRC release. RAN2 needs to also discuss whether a validity timer is required for such a dedicated configuration.

Proposal 2: For the delivery mode 1-based solution, RAN2 needs to discuss whether the reception configuration of the MTCH is provided through RRC reconfiguration or RRC release.

Proposal 3: For the delivery mode 1-based solution, RAN2 needs to discuss whether the configuration for the UE to receive the MTCH can always be considered valid or is valid only during a certain period of time (e.g., using a validity timer).

Another issue to consider is the impact of UE mobility under the assumption that “seamless/lossless mobility is not needed” as described in the WID. In Release 17, it is clear that the configuration for receiving the MTCH in delivery mode 1 is valid only within the cell in which the UE is configured. When handover is performed, the target cell reconfigures the UE to a new configuration. On the other hand, when the UE in the inactive state performs mobility in the idle mode, it may be considered as the starting point when the existing configuration for receiving the MTCH is no longer valid within the reselected cell (i.e., a new cell).

In order for the UE to be handed over from a serving cell to a target cell or reconfigured by a reselected cell, requesting a transition of the UE that is always inactive to a connected state (e.g., before or after performing cell reselection) may be the simplest solution with minimal impact on the specification.

Since the configuration for MTCH reception is valid in the RNA, the gNB needs to be able to apply the same configuration in the RNA of each UE. An advantage of this method is that the UE in the inactive state does not need to be reconfigured and can continue receiving the MTCH in the RNA. On the other hand, the RNA is UE-specific, which leads to increased network complexity.

A more flexible and less complex method may be that the gNB provides a cell list in the configuration and that the configuration is considered valid in the cells included in the list. The cell list can be configured to be either cell-specific, UE-specific, RNA-related, MRB area-specific, or MBS service area-specific, depending on implementation of a NW.

Therefore, the RAN2 needs to discuss whether to introduce the area scope of such configurations.

Proposal 4: For the delivery mode 1-based solution, the RAN2 needs to discuss whether the reception configuration of the MTCH is valid within the serving cell or valid within the area (such as the RNA or cell list).

### Delivery Mode 2—Based Solution

As described above, when the configuration for receiving the MTCH is provided on the MTCH, all configurations, i.e., the MBS session information, can be seen by all UEs, even if there are UEs not joining the multicast session. Therefore, those UEs not joining the multicast session need not to be able to receive the multicast MTCH.

Although the upper layer procedure assumes that the UE cannot receive the MTCH for TMGI of the multicast session within the USD, it is up to the gNB's decision on whether to use delivery mode 1 or delivery mode 2 for delivery of the multicast session. Therefore, the solution to the AS layer is desirable. One of the simplest solutions is to set an indicator in each piece of MBS session information of the MCCH to distinguish between a multicast session and a broadcast session. UEs not joining a multicast session are not able to use the corresponding MTCH. RAN2 needs to discuss whether it is a problem to be solved when the MCCH is used for multicast reception in the inactive state.

Proposal 5: For the delivery mode 2-based solution, RAN2 needs to consider whether a UE needs to be not allowed to use a multicast MTCH if the UE is not joining the corresponding multicast session.

Another problem worth considering is the process of switching from delivery mode 1 to delivery mode 2 while receiving a multicast session. Although WID states “seamless/lossless mobility is not required”, some degree of service continuity needs to be ensured as part of the service requirements and expectations of the multicast session.

When the UE starts to acquire the MCCH and the MTCH after an RRC state transition shortly after being released to be inactive, a service interruption at the time of switch of the delivery mode may be possibly excessive. For this reason, such a service interruption needs to be minimized although the service is not seamless/lossless.

A possible solution is that the gNB provides the MCCH to the UE through a dedicated signal while the UE is still connected. In this method, service interruptions can be reduced because the UE can start receiving the MTCH before transitioning to the inactive state. One question is whether the dedicated signaling is an RRC reconfiguration or RRC release, so if the dedicated signaling is the RRC reconfiguration, the UE is considered to be able to start reception of the MTCH early.

Proposition 6: For the delivery mode 2-based solution, RAN2 needs to discuss whether service interruptions need to be minimized when switching from delivery mode 1 to delivery mode 2.

Proposal 7: If the proposal 6 can be agreed, RAN2 needs to further discuss whether to provide the MCCH through dedicated signaling. Whether dedicated signaling is an RRC reconfiguration or RRC release needs to be further studied.

### REFERENCE SIGNS

1: Mobile communication system
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method used in a mobile communication system configured to provide a multicast/broadcast service (MBS), the communication method comprising the steps of:
receiving, by a user equipment in a radio resource control (RRC) connected state, one or more multicast sessions from a network by using an MBS configuration of each of the one or more multicast sessions; and
receiving, by the user equipment from the network, an RRC release message for causing the user equipment to transition to an RRC inactive state,
wherein the RRC release message comprises information indicating one of the multicast sessions to which the MBS configuration is continuously applied.

2. The communication method according to claim 1, wherein
the RRC release message comprises a list of MBS session IDs of the multicast sessions to which the corresponding MBS configurations is continuously applied.

3. A user equipment in a mobile communication system configured to provide a multicast/broadcast service (MBS), the user equipment comprising
a receiver configured to receive, when the user equipment in a radio resource control (RRC) connected state, one or more multicast sessions from a network by using an MBS configuration of each of the one or more multicast sessions, wherein
the receiver is configured to receive from the network, an RRC release message for causing the user equipment to transition to an RRC inactive state,
the RRC release message comprises information indicating one of the multicast sessions to which the MBS configuration is continuously applied.

4. A chipset for a user equipment in a mobile communication system configured to provide a multicast/broadcast service (MBS), the chipset configured to execute processes of:
receiving, when the user equipment in a radio resource control (RRC) connected state, one or more multicast sessions from a network by using an MBS configuration of each of the one or more multicast sessions; and
receiving from the network, an RRC release message for causing the user equipment to transition to an RRC inactive state,
wherein the RRC release message comprises information indicating one of the multicast sessions to which the MBS configuration is continuously applied.

5. A non-transitory computer-readable medium comprising, stored thereupon, computer program instructions for execution by a user equipment in a mobile communication system configured to provide a multicast/broadcast service (MBS), the program instructions being configured to cause the user equipment to execute processes of:
receiving, when the user equipment in a radio resource control (RRC) connected state, one or more multicast sessions from a network by using an MBS configuration of each of the one or more multicast sessions; and
receiving from the network, an RRC release message for causing the user equipment to transition to an RRC inactive state,
wherein the RRC release message comprises information indicating one of the multicast sessions to which the MBS configuration is continuously applied.

6. A mobile communication system configured to provide a multicast/broadcast service (MBS), the mobile communication system comprising a user equipment and a network,
the user equipment is configured to receive, when the user equipment is in a radio resource control (RRC) connected state, one or more multicast sessions from the network by using an MBS configuration of each of the one or more multicast sessions, and
the user equipment is configured to receive from the network, an RRC release message for causing the user equipment to transition to an RRC inactive state,
wherein the RRC release message comprises information indicating one of the multicast sessions to which the MBS configuration is continuously applied.
